(19) United States
(12) Patent Application Publication
(10) Pub. No.: US 2025/0065499 A1
(43) Pub. Date: Feb. 27, 2025

(54) Reducing Kinematic Error

(71) Applicant: ABB Schweiz AG, Baden (CH)

(72) Inventors: Arne Wahrburg, Weiterstadt (DE); Richard Roberts, Gilching (DE); Stig Moberg, Västerås (SE)

(73) Assignee: ABB Schweiz AG, Baden (CH)

(21) Appl. No.: 18/948,695

(22) Filed: Nov. 15, 2024

Related U.S. Application Data
(63) Continuation of application No. PCT/EP2022/063353, filed on May 17, 2022.

(51) Int. Cl. B25J 9/16

(52) U.S. Cl. CPC B25J 9/1651

(57) ABSTRACT

A method for reducing kinematic error in a joint includes providing an acceleration sensor; selecting a trajectory to be followed by the acceleration sensor; estimating expected acceleration values the sensor will experience along the trajectory; outputting initial commands for moving the sensor along the trajectory; obtaining corrected commands by adding to a parameter specified in an initial command a kinematic error correction and inputting the corrected commands into a joint controller; recording acceleration values to which the sensor is subject while moving according to the corrected commands; judging whether a deviation between the expected acceleration values and the recorded acceleration values exceeds a predetermined threshold, and when the deviation is judged to exceed the threshold, modifying the kinematic error correction so as to reduce the deviation.

### CROSS-REFERENCE TO RELATED APPLICATIONS

The instant application claims priority to International Patent Application No. PCT/EP2022/063353, filed May 17, 2022, which is incorporated herein in its entirety by reference.

### FIELD OF THE DISCLOSURE

The present disclosure generally relates to systems and methods for reducing kinematic error when controlling the movement of a joint in a robot manipulator.

### BACKGROUND OF THE INVENTION

A robot manipulator comprises a plurality of links, which are coupled to each other, to a base or to an end effector by rotatable joints. Rotation of such a joint is driven by a motor, typically via a reduction gear. Play and inaccuracy in the manufacture of the motors and gears affects the accuracy with which the position and the speed of an end effector at the distal end of the robot arm can be controlled. Harmonic drive gears are widely used as reduction gears in robots, since they are practically play-free, but inevitable inaccuracies, such as eccentricity of a gearwheel or spline, would still cause the rotation speed of a joint to fluctuate even if its motor could be driven at a perfectly constant speed, so that the position of the joint can deviate from what one would expect based knowing the position of the motor and the transmission ratio of the reduction gear. This deviation is commonly referred to as kinematic error or transmission error.

### BRIEF SUMMARY OF THE INVENTION

Systems and methods described through the embodiments presented herein provide simple and cost-efficient way of reducing kinematic error in a robot joint. According to an aspect of the present disclosure, a method for reducing kinematic error in a j-th joint between distal and proximal portions of a manipulator, the joint having associated to it a motor for driving rotation thereof, a measurement device for measuring a rotation angle of the motor, a controller connected to the motor and to the measurement device for controlling at least the rotation angle of the motor based on input position commands, and a trajectory generator for outputting position commands, the method comprising the steps of providing an acceleration sensor in the distal portion, selecting a trajectory to be followed by the acceleration sensor, estimating expected acceleration values to which the sensor is expected to be subject along said trajectory, outputting, by said trajectory generator, initial commands for moving the sensor along the trajectory, obtaining corrected commands by adding to a parameter specified in an initial command a kinematic error correction, and inputting the corrected position commands into the controller, recording acceleration values to which the sensor is subject while moving according to the corrected position commands, judging whether a deviation between the expected acceleration values and the recorded acceleration values exceeds a predetermined threshold, and when the deviation is judged to exceed the threshold, modifying the kinematic error correction so as to reduce the deviation.

Since the kinematic error reflects inaccuracies of a specific joint, its correction should be determined individually for each joint based on a characterization thereof. However, precisely since it is the kinematic error which reflects the individual characteristics of each joint, the trajectory generator and the controller can be identical for all joints of manipulators manufactured in a same series. A robotic system to which the method of the invention is applied can therefore conveniently be manufactured in series; inaccuracies that are specific to individual specimens of the series can be compensated by implementing, in each joint of each specimen robotic system, an appropriate kinematic error correction. Therefore, once the kinematic error correction is known, compensation is easy and cost efficient. Determination and implementation of the kinematic error correction can be done after assembly of each specimen robotic system by the manufacturer, or whenever a joint has been repaired or serviced.

### BRIEF DESCRIPTION OF THE SEVERAL VIEWS OF THE DRAWING(S)

FIG. 1 is a block diagram of a robotic system in accordance with the disclosure.

FIG. 2 is a perspective view of the manipulator of the system of FIG. 1.

FIG. 3 is a cross section of a harmonic drive gear in accordance with the disclosure.

FIG. 4 is a pose assumed by the manipulator while carrying out the method in accordance with the disclosure for one of its joints.

FIG. 5 is a pose assumed by the manipulator while carrying out the method in accordance with the disclosure for another of its joints.

### DETAILED DESCRIPTION OF THE INVENTION

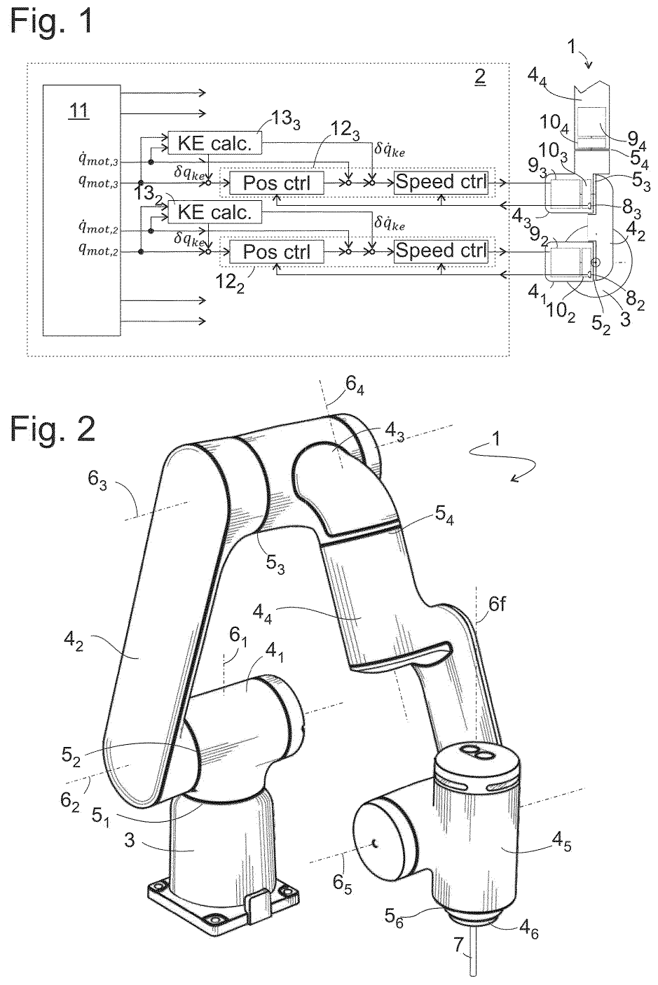

FIG. 1 is a schematic view of a robot system comprising an articulated robot arm 1 and a controller 2, in which the method of the invention can be applied. The robot arm 1, shown in more detail in FIG. 2, has a stationary base 3 fixed to a support, and a plurality of links 4ⱼ, where j=1 . . . 6, rotatably connected to each other and to the base 3 by joints 5ⱼ. The joint 5₅ connecting links 4₄, 4₅, is concealed behind link 4₅. Each joint 5ⱼ enables a rotation of the link 4ⱼ on its distal side by an axis 6ⱼ. Axis 6₁ is vertical, axes 6₂ and 6₃ are horizontal; the orientations of the other axes vary. Each joint 5ⱼ has a motor associated with it for driving its rotation; the motor can be provided in a member on the proximal side of the joint and be connected to a member on the distal side thereof, or vice versa. In the robot arm of FIG. 2, joints 5₁, 5₂, 5₃ have their motors in members on their proximal side, i.e. in base 3 and links 4₁, 4₅, respectively; joints 5₃, 5₄ and 5₅ have the motors on their distal side, in links 4₃, 4₄ and 4₅, respectively.

The most distal link 4₆ has a tool releasably mounted to it. The tool can be a three-dimensional acceleration sensor 7, or it can be a gripper holding such a sensor 7.

Motors 9₂, 9₃, and 9₄ associated to joints 5₂, 5₃, 5₄ and harmonic drive gears 10₂, 10₃, and 10₄ connecting these motors to links 4₂, 4₂ and 4₃, respectively, are shown in FIG. 1. Each motor 9ⱼ has a resolver 8ⱼ associated to it as a measurement device for measuring the rotation angle q*_{arm,j} of its output shaft.

Controller 2 comprises a trajectory generator 11 for outputting, with an appropriate timing, position and speed commands to joint controllers 12ⱼ associated to a specific joint 5ⱼ as would be required for having the sensor 7 follow a predetermined trajectory assuming that the joints are free from kinematic error. Each joint controller 12ⱼ further has a kinematic error calculator 13ⱼ associated to it for superimposing a correction onto the commands output by the trajectory generator 11, as will be explained in detail below.

FIG. 3 is a schematic cross section of a harmonic drive gear 10ⱼ. A wave generator 14 is rigidly coupled to an output shaft 15 of motor 9ⱼ; so as to rotate inside flex-spline 16 and pressing its teeth into engagement with a circular spline 17 surrounding it. When the number of teeth of the circular spline 17 is i_{c} and that of the flex-spline 16 is i_{f}, the transmission ratio of the gear 10ᵢ is

$$R = \frac{{i}_{f} - {i}_{c}}{{i}_{f}} .$$

Since the flex-spline 16 is rotating in a direction opposite to that of the wave generator 14, points of the two currently in contact will meet again after the wave generator 14 has rotated by 2πⁱ^{_{f}}/i_{c}.

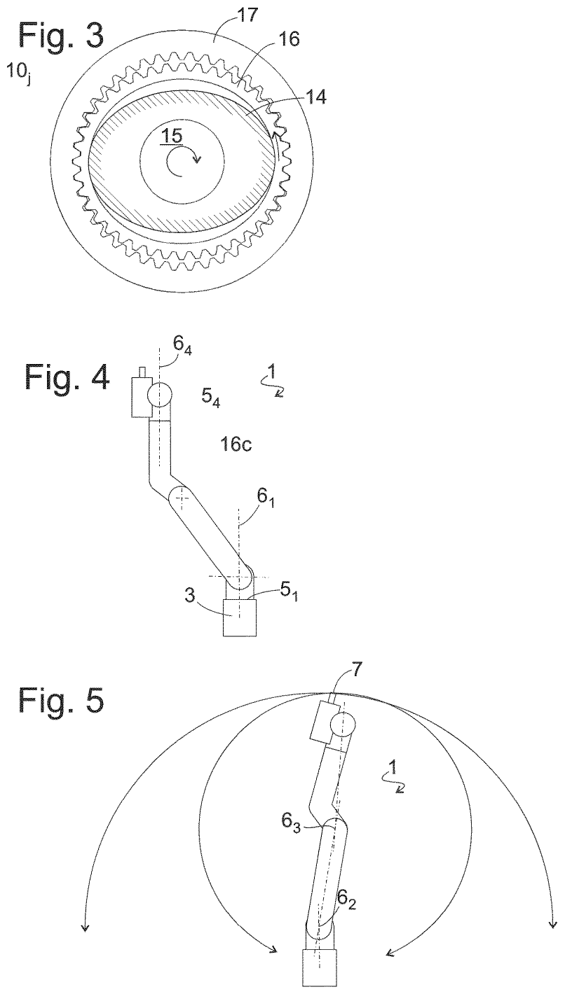

In order to find the kinematic error of joints 5₁ or 5₄, the manipulator 1 is brought into a pose as shown in FIG. 4, where the axis 6₁ or 6₄ associated to the joint in question is vertical, and the gravity acceleration detected by sensor 7 does not vary while rotating around the axis at constant speed. Therefore, in step b of the exemplary method described herein, such a rotation is chosen as a trajectory in which to measure the acceleration of sensor 7. In the pose of FIG. 4, the joint 5₁ or 5₄ may carry out several revolutions without stopping while recording the acceleration detected by sensor 7. In laboratory coordinates, the direction of the centrifugal acceleration to which the sensor is subject should vary, but since the sensor 7 itself rotates too, the acceleration is invariant in the sensor's frame of reference. Thus, any fluctuations in the acceleration detected by sensor 7 can be attributed to imperfections of the motor 9₁ or 9₄ and its respective reduction gear 10₁ or 10₄.

Axes 6₂ and 6₃ are always horizontal, so that while the sensor 7 is rotating around one of these axes, the direction of gravity acceleration will inevitably vary in the reference frame of the sensor 7. Since the harmonic drive gears 10₂ and 10₃ will have a reduction much smaller than 1, fluctuations of the acceleration whose frequency is only a small integer multiple of the motor rotation frequency or of R times the motor rotation frequency can be expected to originate from imperfections of the motors and the reduction gears. For measuring these, the manipulator can be brought into a pose as shown in FIG. 5, and swing back and forth around axis 6₂ or 6₃ at constant motor speed as far as possible while avoiding a collision of links of the manipulator 1 with each other or with a support, as shown by double pointed arrows in FIG. 5.

In order to determine the kinematic error of, e.g., joint 5ⱼ, trajectory generator 11 outputs a trajectory, in at least a section of which the motor 9ⱼ is controlled to rotate at a constant speed \dot{q}_{mot,j}, while all other motors are standing still. The rotation frequency of the motor 9ⱼ in this section chosen equal to a resonance frequency of the manipulator 1, so that if there are fluctuations in the speed of the motor 9ⱼ or of the harmonic drive gear 10ⱼ driven by it, these can be expected to excite the vibration and thus produce an acceleration fluctuation that is clearly and easily detectable.

At least in the constant speed section of the trajectory, accelerations detected by sensor 7 are recorded. Although recording might be done separately for all three components αₓ, α_{y}, α_{z} of the acceleration vector, it is convenient to record only its magnitude a=\sqrt{aₓ²+a_{y}²+a_{z}²} since then there is no need to bother about the orientation of the sensor 7 with respect to the distal link 4₆ to which it is mounted.

When the trajectory is executed for the first time, and eventual imperfections of joint 5ⱼ are unknown, output of the kinematic error calculator 13ⱼ can be constantly zero, so that commands output by the trajectory generator 11 reach controller 12ⱼ unmodified, and the joint angle will not be exactly q_{arm,J}=R_{qmot,J}, as would be expected when imperfections of motor 9ⱼ and gear 10ⱼ are left unconsidered, but can rather be written as

$${q}_{arm , j} = {Rq}_{mot , j} - {\sum }_{i = 1}^{M} {A}_{i , j} sin ( {k}_{i , j} {q}_{mot , j} + {ϑ}_{i , j} )$$

k being an integer or an integer multiple of i_{f}/i_{c}. I.e., if kinematic error calculator 13ⱼ applied corrections amounting to (equation 1):

$$δ {q}_{ke} = {\sum }_{i = 1}^{M} {A}_{i , j} sin ( {k}_{i} {q}_{mot , j} + {ϑ}_{i , j} )$$

$$δ {\dot{q}}_{ke} = {\sum }_{i = 1}^{M} {k}_{i} {A}_{i , j} cos ( {k}_{i} {q}_{mot , j} + {ϑ}_{i , j} )$$

the ideal relationship q_{arm,J}=R_{qmot,j} would be satisfied.

Typically, the most important contributions to this sum are for

$${k}_{1} = \frac{{2}^{{i}_{f}}}{{i}_{c}}$$

and k₂=2, i.e. at frequencies

$$\frac{2 {i}_{f}}{{i}_{c}} \frac{{\dot{q}}_{mot , j}}{2 π} and \frac{{\dot{q}}_{mot , j}}{2 π}$$

respectively. One might therefore approximate δqₖₑ assuming that its only two summands are these two. Alternatively, a spectrum analysis of the collected acceleration data can be carried out in order to identify the frequencies that make the most important contributions.

In the absence of a kinematic error, the acceleration measured by the sensor 7 should be constant while the joint 5₁ or joint 5₄ is rotating at constant speed starting from the pose of FIG. 4, or should vary in proportion to the sine or cosine of the arm angle q_{arm, j}, i.e. at a practically negligible rate when one of joints 5₂ and 5₃ is oscillating as shown in FIG. 5.

As a measure A of the quality with which the manipulator is controlled, the amount or square of a difference between a magnitude a(t) or a(q_{mot,j}) of the acceleration measured while moving and the magnitude expected at that time or position can be averaged or integrated over a trajectory portion in which the sensor is moved at a constant motor speed \dot{q}_{mot,j}:

$$Λ = {\int }_{{q}_{start}}^{{q}_{end}} \vert a ( {q}_{mot , j} ) - {a}_{exp} \vert {dq}_{mot , j} ,$$

$$Λ = {\int }_{{q}_{start}}^{{q}_{end}} {( a ( {q}_{mot , j} ) - {a}_{exp} )}^{2} {dq}_{mot , j} ,$$

$$Λ = {\int }_{{t}_{start}}^{{t}_{end}} \vert a ( t ) - {a}_{exp} \vert dt ,$$

$$or$$

$$Λ = {\int }_{{t}_{start}}^{{q}_{end}} {( a ( t ) - {a}_{exp} )}^{2} dt ,$$

wherein the expected acceleration αₑₓₚ may be calculated based on the motor speed \dot{q}_{mot,j}, the transmission ratio and the radius of sensor 7 relative to axis 6ⱼ, or may be derived by low-pass filtering one of α(q_{mot,j}) or α(t) or obtaining some other form of moving average over an interval shorter than [qₛₜₐᵣₜ, q_{end}] or [tₛₜₐᵣₜ, t_{end}], respectively.

Alternatively, when a spectral analysis of the acceleration data α(q_{mot,j}) has been carried out, a sum of amplitudes of the most important spectral components of the acceleration might be used for the same purpose. This analysis can be confined to a spectral range where such components can be expected to exist. When there is reasonable certainty, based, for example, on experimental evidence gained from a plurality of harmonic drive gears of identical design, that contributions at frequencies different from

$${k}_{1} = \frac{{i}_{f}}{{i}_{c}} \frac{{\dot{q}}_{mot , j}}{π}$$

$$and$$

$${k}_{2} = \frac{{\dot{q}}_{mot , j}}{π}$$

are insignificant, the spectral analysis can be confined to a frequency range [k₁−ε, k₂+ε].

The quality Λ is a function of the adaptable parameters A_{i,j}, ϑ_{i,j} in eq. (1) above. In order to optimize it, its gradient is determined by making a small change δA_{i,j} or δϑ_{i,j} to each one of these parameters in turn, having the trajectory generator 11 output the trajectory again while having kinematic error calculator 13ⱼ apply to it the corrections δqₖₑ, δ\dot{q}ₖₑ that result from the changed parameter, re-measuring the accelerations and from the data thus obtained, calculating the quality Λ(A_{i,j}, ϑ_{i,j}+δA_{i,j}) or resulting from the parameter change. Thus, the gradient in the direction of A_{i,j} is approximated as (equation 2):

$$\frac{\partial Λ}{\partial {A}_{i , j}} = \frac{Λ ( {A}_{i , j} , {ϑ}_{i , j} + δ {A}_{i , j} ) - Λ ( {A}_{i , j} , {ϑ}_{i , j} )}{δ {A}_{i , j}}$$

$$\frac{\partial Λ}{\partial {ϑ}_{i , j}} = \frac{Λ ( {A}_{i , j} , {ϑ}_{i , j} + {δϑ}_{i , j} ) - Λ ( {A}_{i , j} , {ϑ}_{i , j} )}{{δϑ}_{i , j}}$$

When varying amplitude parameters A_{i,j}, care must be taken that these should be positive but small enough not to cause potentially harmful vibrations of the manipulator 1.

When the gradient has been determined for all parameters A_{i,j}, ϑ_{i,j}, their values are updated according to (equation 3):

$${A}_{i , j} : \text{=} {A}_{i , j} - sign ( \frac{\partial Λ}{\partial {A}_{i , j}} ) Δ {A}_{i , j}$$

$${ϑ}_{i , j} : \text{=} {ϑ}_{i , j} - sign ( \frac{\partial Λ}{\partial {ϑ}_{i , j}} ) {Δϑ}_{i , j}$$

where step sizes ΔA_{i,j}, Δϑ_{i,j} may be different from those δA_{i,j} used for determining the gradient.

Based on acceleration measurements obtained using the parameters A_{i,j}, ϑ_{i,j}, modified according to eq. (3), the quality Λ is re-calculated.

This process is repeated until either Λ has dropped below a predetermined threshold, a maximum number of iterations has been carried out or no notable changes of Λ have been observed over a certain number of iterations.

In the course of such iterations, the spectral composition of the acceleration measurements is likely to vary. If for each iteration the spectral composition of the acceleration measurements is determined and the most significant components kᵢ, i=1 . . . M are selected to be compensated, the set of components kᵢ may change from one iteration to the next, and compensation will proceed from more important components to less important ones in the course of the iterations, allowing to compensate a large number of parameters with limited effort.

The speed of convergence of the process can be increased by adapting the step widths ΔA_{i,j}, Δϑ_{i,j} for a given spectral component kᵢ. If the sign of the gradient sign

$$( \frac{\partial Λ}{\partial {A}_{i , j}} )$$

or sign

$$( \frac{\partial Λ}{\partial {ϑ}_{i , j}} )$$

for a given parameter A_{i,j}, or ϑ_{i,j} component is the same in two successive iterations, the step width is increased according to

$$\begin{matrix}Δ {A}_{i , j} : \text{=} {β}^{+} Δ {A}_{i , j} \\ {Δϑ}_{i , j} : \text{=} {β}^{+} {Δϑ}_{i , j}\end{matrix} , {β}^{+} > 1.$$

else it is decreased according to

$$Δ {A}_{i , j} : \text{=} {β}^{-} Δ {A}_{i , j}$$

$${Δϑ}_{i , j} : \text{=} {β}^{-} {Δϑ}_{i , j}$$

When one of the above-mentioned conditions for terminating the process are fulfilled, the kinematic error calculator 13ⱼ is loaded with the values of A_{i,j}, ϑ_{i,j} obtained in the process, and will furthermore apply the kinematic error correction of eq. (1) applying these values to any position command output by trajectory generator 11 to its associated joint controller 12ⱼ.

The entire manipulator 1 is compensated by applying the above procedure successively to each of its joints 5ⱼ.

When all joints have been compensated, the sensor 7 is removed in order to be used on another manipulator.

In the present disclosure, the acceleration sensor doesn't have to be provided permanently, since it is needed only for determination of the kinematic error. It can be removed after this has been accomplished, and can be re-used on a different manipulator. The method is therefore very cost-efficient when applied to manipulators manufactured in series; it can also be applied when carrying out maintenance or repair work on legacy manipulators that have no such sensor.

When the acceleration sensor has been mounted, it can be used to find kinematic error corrections for all joints between it and a stationary base of the manipulator. It therefore best placed at a distal end of the manipulator.

Where the distal end comprises a gripper, the gripper can be used for holding the acceleration sensor while the method is being carried out.

When a step is carried out for the first time, and the kinematic error is still unknown, the position commands received by the controller will be those output by the trajectory generator, so that deviations of the measured acceleration from its expected value are representative of the entire kinematic error. When the step is repeated with a nonzero correction applied, residual deviations allow to judge whether the quality of the correction is sufficient, and, if necessary, to improve it.

The commands mentioned above can be position commands in which the specified parameter is a position and speed commands, in which the specified parameter is a speed.

There are no specific limitations on the trajectory selected in step b., however, finding the kinematic error correction for the j-th joint is facilitated if the trajectory does not involve movements of other joints≠j of the manipulator but the one to which the kinematic error correction will be associated.

Estimating the expected acceleration can be quite simple; in fact when the selected trajectory is a constant speed rotation around an axis, the expected acceleration can be constant, or will have a component proportional to a circular function of the joint angle, caused by gravity. It is preferred, therefore, that at least part of the trajectory should be a constant speed rotation; when the range of rotation of the joint is limited, several rotations in alternating directions may combined in a trajectory defining an oscillating movement. In fact, the expected acceleration doesn't even have to be calculated in advance; when the motor of the joint is controlled to rotate at a constant speed, the acceleration to which the sensor is subject at any particular instant can be expected to be the average of accelerations experienced before and after; i.e. the expected acceleration can be determined while moving the sensor along the selected trajectory by calculating a moving average of measured accelerations.

It has been observed that the kinematic error of a motor and reduction gear

assembly can be approximated precisely by a sum of a small number of circular functions of different frequencies. Contributions from the motor and from an input shaft of the reduction gear, rotating at the same frequency as the motor, can be described by circular functions (i.e. sine or cosine functions) of integer multiples n of a rotation angle q_{mot,j} of the motor.

When the reduction gear is a harmonic drive gear having a circular spline with i_{c} teeth and a flex-spline whose number of teeth i_{f} is slightly smaller than i_{c}, the orientation of the wave generator driven by the motor and the flex-spline becomes identical after every i_{f}/i_{c} rotations, causing contributions to the kinematic error at m i_{f}/i_{c} times the rotation frequency of the motor, where m is a small integer.

While in normal operation of the robot one would usually avoid trajectories that require the motor to operate at a resonance frequency of the robot arm, in order not to excite vibrations, in the method of the invention a speed for the trajectory is preferably chosen so that the motor frequency or a harmonic thereof is a resonance frequency, preferably the lowest resonance frequency, of the manipulator, since a vibration of the manipulator thus excited will yield a clearly detectable deviation between expected and actual acceleration values. Preferably, the speed is chosen so that the 2nd harmonic of the motor frequency coincides with the resonance frequency.

An acceleration sensor will typically be sensitive to accelerations in all three directions of space. Since vibrations may occur in any direction, the amount of data to be processed can be reduced by combining the three components of a recorded or estimated acceleration vector into a single scalar quantity. This combining step can involve calculating the sum of squares of the three components of the vector, in order to obtain a scalar quantity that is invariant under rotation of the sensor.

The judgment step can be facilitated by performing a spectral analysis, e.g., a Fourier transform, (in terms of the motor rotation angle q_{mot,j}, preferably) of the recorded acceleration values. Here, the deviation can be regarded as excessive if any spectral component of the Fourier transform exceeds a predetermined threshold. Judgment can be based on just one such spectral component, preferably one whose frequency is twice the motor frequency, since this one is likely to be the strongest component in the Fourier transform.

When the kinematic error correction has been modified in step h., steps d. to g. should be repeated in order to find out whether the new kinematic error correction satisfies the threshold of step g. or whether, at least, the deviation of the new kinematic error correction is less than that of the old one.

Theoretically, the kinematic error function could be modified in step h. following a simple trial and error scheme, but in that case finding a satisfactory kinematic error function is likely to take a long time. Processing time can be shortened by estimating a gradient of the deviation in terms of the weighting coefficients of the kinematic error function and then adding said gradient times a scalar factor to a vector formed by the weighting coefficients of the kinematic error function.

When the vector formed by the weighting is close to optimum, the direction of gradients obtained in successive iterations of step I) can be expected to change more strongly from one iteration to the next than when the vector is still far from optimum. Therefore, the number of iterations needed to approach that optimum can be reduced by increasing the above-mentioned scalar factor when the change of direction is below a given lower threshold and by decreasing the scalar factor when the change of direction is above a given upper threshold.

The change of direction can be regarded as falling short of the lower threshold when there is no change of sign between components of successive gradients; it can be regarded as exceeding the upper threshold when at least one component changes its sign from one gradient to the next.

According to an aspect of the present disclosure, a robotic system can include a manipulator having a proximal portion, a distal portion, a joint connecting said proximal and distal portions and a motor for driving rotation of the joint, a measurement device for measuring a rotation angle of the motor a controller connected to the motor and to the measurement device for controlling at least the rotation angle of the motor based on input position commands, a trajectory generator for outputting position commands, an acceleration sensor, preferably removably mounted, in the distal portion of the robot arm.

According to a further aspect, the object is achieved by a computer-readable storage medium having stored thereon a plurality of instructions which, when executed by a processor, cause the processor to carry out at least steps d. to h. of the method described above.

Further features and advantages of the invention will become apparent from the subsequent description of embodiments, referring to the appended drawings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE NUMERALS

1 manipulator
2 controller
3 base
4 link
5 joint
6 axis
7 acceleration sensor
8 resolver
9 motor
10 harmonic drive gear
11 trajectory generator
12 joint controller
13 kinematic error calculator
14 wave generator
15 output shaft
16 flex-spline
17 circular spline

What is claimed is:

1. A method for reducing kinematic error in a joint between distal and proximal portions of a manipulator, the joint having associated to it a motor for driving rotation thereof, a measurement device for measuring a rotation angle of the motor, a joint controller connected to the motor and to the measurement device for controlling at least the rotation angle of the motor based on input position commands, and a trajectory generator for outputting position commands, the method comprising:
a. providing an acceleration sensor in the distal portion;
b. selecting a trajectory to be followed by the acceleration sensor;
c. estimating expected acceleration values to which the sensor is expected to be subject along said trajectory;
d. outputting, by the trajectory generator, initial commands for moving the sensor along the trajectory;
e. obtaining corrected commands by adding to a parameter specified in an initial command a kinematic error correction, and inputting corrected commands into the joint controller;
f. recording acceleration values to which the sensor is subject while moving according to the corrected commands;
g. judging whether a deviation between the expected acceleration values and the recorded acceleration values exceeds a predetermined threshold, and
h. when the deviation is judged to exceed the threshold, modifying the kinematic error correction so as to reduce the deviation.

2. The method of claim 1, wherein the commands are at least one of position commands in which the specified parameter is a position and speed commands, in which the specified parameter is a speed.

3. The method of claim 1, wherein in step b) the trajectory is selected so that the expected acceleration values or magnitudes thereof are constant along at least part of the trajectory, and optionally, wherein the trajectory defines an oscillating movement.

4. The method of claim 1, wherein the kinematic error correction is a weighted sum at least of circular functions of integer multiples of the rotation angle of the motor.

5. The method of claim 4, wherein the joint further comprises a harmonic drive gear, wherein the kinematic error correction is a weighted sum also of circular functions of integer multiples of the rotation angle multiplied by i_{f}/i_{c}, wherein i_{f} is the number of teeth of a flex-spline of the harmonic drive gear, and i_{c} is the number of teeth of a circular spline thereof.

6. The method of claim 1, wherein in step b) a speed for the trajectory is chosen so that the motor frequency or a harmonic thereof is a resonance frequency of the manipulator.

7. The method of claim 1, wherein the expected acceleration values of step c. and/or the recorded acceleration values of step f. are vector quantities, and the judgment of step g. involves combining all three components of each vector quantity into a single scalar quantity.

8. The method of claim 1, of the preceding claims, wherein the judgment of step g. is based on a spectral analysis of the recorded acceleration values.

9. The method of claim 1, wherein the judgment of step g. is based on a spectral component of the recorded acceleration values whose frequency is twice the motor frequency.

10. The method of claim 1, wherein steps d. to g. are repeated when the kinematic error correction has been modified in step h.

11. The method of claim 10, wherein modifying the kinematic error function in step h. comprises a sub-step of estimating a gradient of the deviation in terms of the weighting coefficients of the kinematic error correction and adding the gradient, times a scalar factor, to a vector formed by the weighting coefficients of the kinematic error correction.

12. The method of claim 11, wherein the scalar factor is increased if the change of direction of the gradient between successive iterations is below a given lower threshold and is decreased when the change of direction is above a given upper threshold.

13. A robotic system, comprising:
a manipulator having a proximal portion, a distal portion, a joint connecting the proximal and distal portions and a motor for driving rotation of the joint;
a measurement device for measuring a rotation angle of the motor;
a controller connected to the motor and to the measurement device for controlling at least a rotation angle of the motor based on input position commands;
a trajectory generator for outputting position commands; and
an acceleration sensor removably mounted on a distal portion of the manipulator.
